(19) United States
(12) Patent Application Publication
(10) Pub. No.: US 2025/0239657 A1
(43) Pub. Date: Jul. 24, 2025

(54) CONNECTOR INSPECTION DEVICE AND INSPECTION SYSTEM USING THE SAME

(71) Applicant: LG ENERGY SOLUTION, LTD., Seoul (KR)

(72) Inventors: Gabhyung KIM, Troy, MI (US); Junyoung PARK, Holland, MI (US)

(21) Appl. No.: 18/964,215

(22) Filed: Nov. 29, 2024

Related U.S. Application Data
(60) Provisional application No. 63/624,597, filed on Jan. 24, 2024.

(51) Int. Cl. H01M 10/42; G01B 11/00; H01M 10/6567

(52) U.S. Cl. CPC H01M 10/4228; H01M 10/4285; G01B 11/002; H01M 10/6567

(57) ABSTRACT

A connector inspection device includes a body including one end portion and another end portion, the one end portion including a hollow portion to receive a coolant hose and a coolant connector, a positioning device disposed at the body for obtaining a position of the connector inspection device, a shaft disposed in the body and movable toward the one end portion of the body, the shaft movable up to a predetermined distance from an outermost end of the one end portion of the body, and a sensor disposed at the body. When the shaft is positioned at the predetermined distance in the body, the sensor is configured to sense the shaft.

### CROSS-REFERENCE TO RELATED APPLICATION

This application claims priority to and the benefit of U.S. Provisional Application No. 63/624,597 filed on Jan. 24, 2024, the disclosure of which is incorporated herein by reference.

### TECHNICAL FIELD

The present disclosure relates to a connector inspection device and an inspection system using the same.

### BACKGROUND

Due to their characteristics of being able to store and discharge electrical energy many times over the course of its life, secondary batteries are sources of energy for electric vehicles (EVs) or hybrid electric vehicles (HEVs) and the like. Secondary batteries are also storage source of energy in energy storage systems (ESSs) and the like. One goal of secondary batteries is to reduce the use of fossil fuels in motor vehicles that pollute the environment and generate greenhouse gases. In addition, secondary batteries can be used as storage source of energy in a renewable energy source infrastructure providing for eco-friendly and energy efficient source of energy.

Currently, a secondary battery starts with a battery cell, which typically has an operating voltage of about 2.5V to 4.5V. Since a higher output voltage may be required to be practical, a plurality of battery cells may be connected in series. Additionally, a plurality of serially connected battery cells may be connected in parallel to form a battery pack or a battery rack according to the required charge/discharge capacity. A battery pack is typically used in EVs and HEVs, and a battery rack is typically used in ESSs. Accordingly, the number of battery cells included in the battery pack or the battery rack may be variously set depending on the required output voltage and/or charge/discharge capacity.

Since there are multiple battery cells confined in the battery pack or the battery rack, heat generated from the multiple battery cells can add up in the limited confines, such that the temperature could rise quickly and excessively. In other words, to achieve the required output voltage and/or charge/discharge capacity, multiple battery cells are connected in series and in parallel. However, with each battery cell generating heat, the more battery cells that are added, the more heat is generated in the battery pack or the battery rack. However, due to limited space in the battery pack or the battery rack, it is not easy to remove heat generated from the battery cells during charging and discharging. If the heat dissipation of the battery cells is not properly addressed, a thermal runaway phenomenon may occur in one or more battery cells, resulting in the Battery Management System (BMS) shutting down the battery pack or the battery rack, or in a worst scenario, a possibility of one or more battery cells catching fire.

Thus, to address the heat generated in the battery pack or the battery rack, a cooling system is provided to cool the battery pack or the battery rack. The cooling system according to the disclosure may be a cooling system that circulates a coolant through the battery pack or the battery rack. The coolant is introduced to the battery pack or the battery rack through one or more coolant hoses that are connected to the coolant hose connectors, which in turn, are connected to the coolant hose receivers at the battery pack or the battery rack.

The coolant hose connectors are connected to the respective coolant hose receivers in an assembly line. For example, an assembly worker would connect a coolant hose connector to a coolant hose receiver with their hands or with a tool, and then visually inspect for a proper connection. Sometimes a jig is used to confirm that there is no space or it is within tolerance between the coolant hose connector and a bottom of the coolant hose receiver after the connection is made.

However, due to inattentiveness or error, the visual confirmation may be missed or the checking with the jig after the coolant hose connector attachment process may be forgone. A coolant leak test may be performed, but sometimes the faulty connection goes undetected because there is at least a partial connection preventing the coolant from leaking. Such deficiencies can lead to the integrity of the coolant hose connection, posing serious risks, including coolant leaks and potential fire hazards during subsequent operation of the battery pack or the battery rack. Accordingly, there is a desire to create a reliable and robust system that may obviate the deficiencies of the above and other deficiencies. In addition, there is a desire to track, document, and maintain a proper record of the coolant hose connector attachments with respect to the battery pack or the battery rack for future evaluation and assessment, among others.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

The present disclosure aims to provide a proper connection of a coolant hose connector with a coolant hose receiver by implementing a coolant hose connector inspection device. In one embodiment, this device may press the coolant hose connector to the specified height for complete connection. Upon reaching the designated height, a sensor is triggered, allowing for a positioning device to validate the connection status.

The coolant hose inspection device addresses the challenge of visually confirming the secure connection of a coolant connector. Traditionally, inspectors rely on visual inspection, leading to difficulties in accurately assessing complete connection, resulting in potential defects such as coolant leaks, shorts, and potential fire hazards. The coolant hose inspection device may enhance the verification of a complete connection.

To solve the above-described problems, the present disclosure provides a connector inspection device including a body that includes one end portion and another end portion, the one end portion including a hollow portion to receive a coolant hose and a coolant connector, a positioning device disposed at the body for obtaining a position of the connector inspection device, a shaft disposed in the body and movable toward the one end portion of the body, the shaft movable up to a predetermined distance from an outermost end of the one end portion of the body, and a sensor disposed at the body. When the shaft is positioned at the predetermined distance in the body, the sensor is configured to sense the shaft.

The predetermined distance may be a distance from the outmost end of the one end portion of the body where the shaft cannot further press the coolant hose connector against a coolant hose receiver.

The sensor may activate when the shaft is positioned at the predetermined distance in the body. In one embodiment, the sensor is a contact switch that is activated when the shaft contacts the contact switch.

The sensor may be configured to communicate with the positioning device when the sensor is activated.

The shaft may include a button for applying a force to push the shaft through the body. The body may include a handle at which the positioning device is disposed.

The positioning device may include a light emitting diode (LED). In one embodiment, the LED may be an infrared (IR) LED.

The present disclosure provides for a monitoring system including the connector inspection device, that further includes a camera to capture light of the LED in order to determine at least an X-Y coordinate of the positioning device. The camera may capture light of the LED indicating that the sensor is activated.

The monitoring system may be configured to sent data including the at least X-Y coordinate of the positioning device and the activation of the sensor to a manufacturing execution system (MES).

The monitoring system may include a display to display at least one or more coolant hose connectors, and at least one or more indicators to indicate a status of the at least one or more coolant connectors.

A first indicator may indicate a coolant hose connector in which the connector inspection device is to be applied.

When the display system receives data including at least the X-Y coordinate of the positioning device and the activation of the sensor, the display device may match the at least X-Y coordinate of the positioning device with the coolant hose connector indicated by the first indicator, and when the at least X-Y coordinate of the positioning device does not correspond with the position of the coolant hose connector, the display system may continue displaying the first indicator.

When the at least X-Y coordinate of the positioning device corresponds with the position of the coolant hose connector, the display system may change the first indicator to a second indicator.

A third indicator may indicate a next coolant hose connector in which the connector inspection device is to be applied.

One or more fourth indicators may indicate one or more coolant hoses connectors in which the connector inspection device has not been applied.

The coolant hose connector inspection device may effectively resolve the technical problem of unreliable visual confirmation during the coolant connector attachment process. By introducing the coolant hose connector inspection device, the traditional challenges of manual inspection may be overcome. The coolant hose connector inspection device may apply pressure to the coolant hose connector until it reaches the specified height for complete connection. This method ensures a quantitative and precise verification process, addressing the inaccuracies associated with visual confirmation. The incorporation of a sensor and a positioning device may further enhance the reliability of the connection status validation, mitigating the risks of defects such as coolant leaks, shorts, and potential fire hazards that may arise from incomplete connector attachment.

The coolant hose connector inspection device may not only enhance the precision of the coolant hose connector attachment, but may also allow for re-inspection and reconnection of partially attached connectors, addressing a limitation in current practices.

Overall, the coolant hose connector inspection device may offer a more robust and effective solution to the technical challenges associated with coolant connector verification.

While the present disclosure outlines an exemplary coolant hose connector inspection device, alternative implementations are contemplated and covered by the disclosure. For example, variations in the design of the coolant hose connector inspection device or the incorporation of different pressure-applying mechanisms are contemplated and covered by this disclosure.

Additionally, alternative sensing technologies could be employed for connection status verification, such as infrared sensors or force sensors. The core objective is to maintain a quantitative and reliable means of confirming coolant connector attachment, and different configurations and technologies may be explored to achieve this goal based on specific application requirements and preferences.

### BRIEF DESCRIPTION OF THE DRAWINGS

The accompanying drawings illustrate an exemplary embodiment of the present disclosure and together with the following detailed description, serve to provide further understanding of the technical features of the present disclosure, and thus the present disclosure is not construed as being limited to the drawings.

FIG. 1A is a diagram illustrating a coolant hose connector that is improperly connected to the coolant hose receiver; and FIG. 1B is a diagram illustrating a coolant hose connector that is properly connected to the coolant hose receiver.

FIG. 2 is a perspective diagram illustrating a coolant hose connector inspection device according to an embodiment of the present disclosure.

FIGS. 3A-3D are diagrams illustrating an assembly process of the coolant hose connector inspection device illustrated in FIG. 2.

FIGS. 4A-4C are diagrams illustrating an operation of the coolant hose connector inspection device illustrated in FIG. 2.

FIGS. 5A-5B are cross-sectional diagrams illustrating an internal operation of the coolant hose connector inspection device illustrated in FIG. 2.

FIGS. 6A-6B are diagrams illustrating an operation of the coolant hose connector inspection device going from one connected coolant hose connector to the next connected coolant hose connector on a battery pack or a battery rack according to an embodiment of the present disclosure.

FIGS. 7A-7D are diagrams illustrating a display displaying a guide for operation of the coolant hose connector inspection device.

FIG. 8 is a diagram illustrating a position sensor apparatus according to another embodiment of the present disclosure.

FIG. 9 is a diagram illustrating another positioning device and a manufacturing execution system (MES) according to an embodiment of the present disclosure.

### DETAILED DESCRIPTION

The present disclosure may be variously changed and have various aspects, and the specific aspects disclosed herein in detail are used to facilitate an understanding of the present disclosure to those skilled in the art.

Therefore, it should be understood that there is no intention to limit the present disclosure to the particular aspects disclosed, and on the contrary, the present disclosure covers all modifications, equivalents, and alternatives falling within the spirit and scope of the present disclosure.

In this application, it should be understood that terms such as “include” or “have” are intended to indicate the presence of a feature, number, step, operation, component, part, or a combination thereof described on the specification, and they do not preclude the possibility of the presence or addition of one or more other features or numbers, steps, operations, components, parts or combinations thereof.

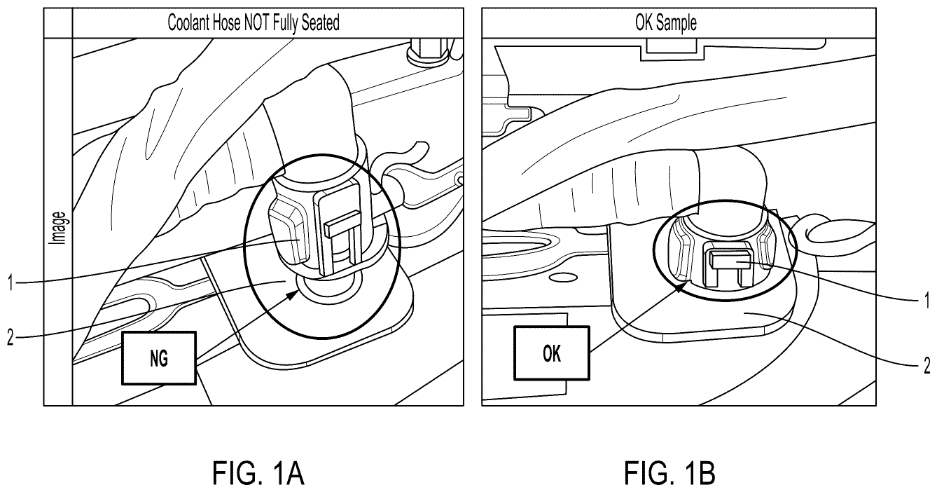

FIG. 1A is a diagram illustrating a coolant hose connector 1 that is improperly connected to the coolant hose receiver 2; and FIG. 1B is a diagram illustrating a coolant hose connector 1 that is properly connected to the coolant hose receiver 2. As shown in FIG. 1A, the coolant hose connector 1 is not fully seated on the coolant hose receiver 2. Thus, there is a possibility that the coolant hose connector 1 may disconnect from the coolant hose receiver 2 resulting in a coolant leak. A battery pack or a battery rack that does not sufficiently receive coolant may overheat resulting in the BMS shutting down the battery pack or the battery rack, and in the worst scenario, the battery pack or the battery rack may catch fire. FIG. 1B, on the other hand, illustrates a coolant hose connector 1 that is fully seated, and thus secured on the coolant hose receiver 3. Hence, it is desired that a device is provided that consistently and reliably provides a coolant hose connection as illustrated in FIG. 1B.

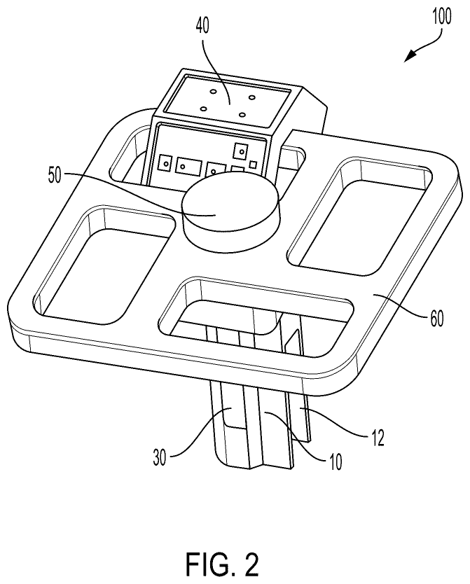

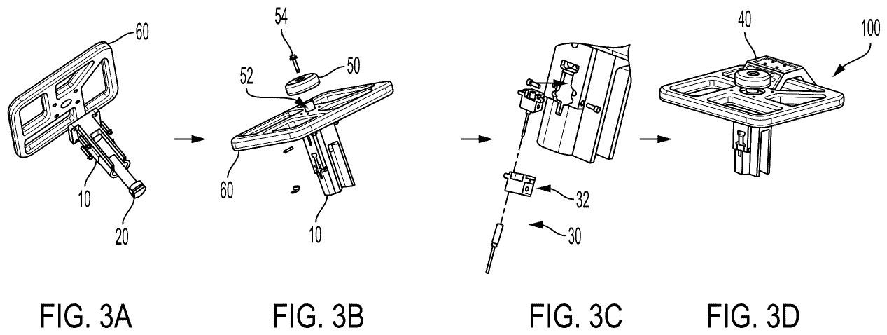

FIG. 2 is a perspective diagram illustrating a coolant hose connector inspection device according to an embodiment of the present disclosure. The coolant hose connector inspection device 100 includes a body 10 and a shaft 20 (see, for example, FIG. 3A) disposed therein, which is able to reciprocate within the body 10. The body 10 may include a hollow portion to accommodate the shaft 20. A coolant hose connecter connected to a coolant hose is received though one end portion of the body 10 such that the received coolant hose connector and the coolant hose are disposed within the hollow portion of the body 10. The hollow portion of the body 10 includes a slit 12 at the one end portion of the body 10 to accommodate the coolant hose extending out from the body 10.

When a force is exerted, the shaft 20 moves toward the one end portion of the body 10 where the coolant hose connector and the coolant hose are located. The shaft 20 may exert a force on the coolant hose connector against the coolant hose receiver such that the coolant hose connector may be seated on the coolant hose receiver, for example, as illustrated in FIG. 1B. The shaft 20 may be able to move up to a predetermined distance from the outermost end of the one end portion of the body 10. For example, this predetermined distance may be the distance between the bottom end of the coolant hose receiver and the top end of the coolant hose connector when the coolant hose connector is properly connected to the coolant hose receiver.

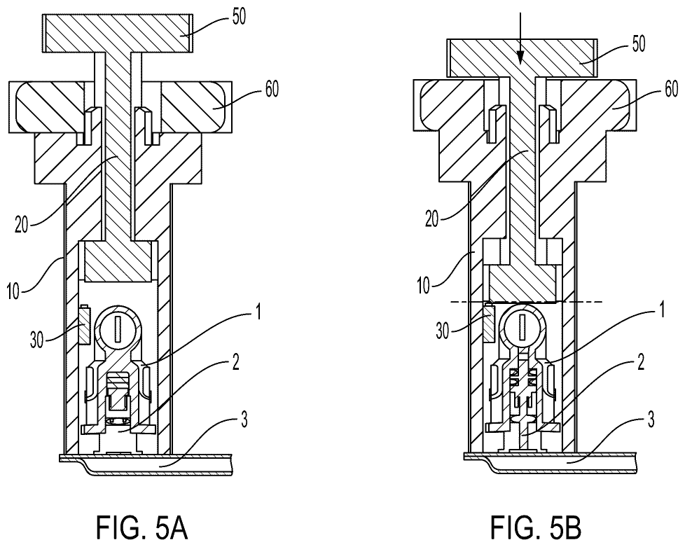

A sensor 30 may be disposed at the body 10. In this embodiment, the sensor 30 may be positioned at the predetermined distance from the outermost end of the one end portion of the body 10 (sec, for example, FIG. 5B). For example, the sensor 30 may be a contact switch. The contact switch may be positioned such that when the shaft 20 presses against the contact switch, the contact switch is activated. However, the sensor 30 need not be limited to a contact switch. For example, the sensor 30 may be a proximity sensor using magnetic or electromagnetic waves. In this instance, the proximity sensor may be positioned at a distance where it can activated when the shaft 20 presses against the coolant hose connector.

The coolant hose connector inspection device 100 may further include a positioning device 40 used to determine a position of the coolant hose connector inspection device 100. For example, the positioning device 40 may be used to provide at least the X-Y coordinates of the coolant hose connector inspection device 100. In another example, the positioning device 40 may be used to provide the X-Y-Z coordinates of the coolant hose connector inspection device 100. The position of the coolant hose connector inspection device 100 may be used to determine whether the coolant hose connector inspection device 100 is over the target coolant hose connector. More details will be described further below. The positioning device 40 may determine its position based on information received by the positioning device 40. For example, reference signal sources may be set up in the inspection area and the positioning device 40 may determine its position through triangulation. It should be noted that other known methods may be used by the positioning device to determine its position. In another example, the positioning device 40 does not determine its position, but rather generates a signal that may be used to determine the position of the positioning device 40. For example, the positioning device 40 may emit light using a light emitting diode (LED) that is detected by a detector and used to determine the position of the positioning device 40. More details will be described further below.

The coolant hose connector inspection device 100 may include a button 50, which is connected to the shaft 20. However, it should be noted that the button may not be required in the coolant hose connector inspection device 100. The button 50 may be provided for ease of a user in applying a force to push the shaft 20 through the hollow frame 10. In the absence of the button 50, the user could push the shaft 20 by applying force at one end of the shaft 20. As another example, if the coolant hose connector inspection device is installed, for example, in a machine that can exert force on the shaft 20, the button 50 may not be required. The coolant hose connector inspection device 100 may include a handle 60. However, it should be noted that the handle 60 may not be required in the coolant hose connector inspection device 100. The handle 60 may be provided for case of a user to manipulate the coolant hose connector inspection device 100. In the absence of the handle 60, the user could manipulate the coolant hose connector inspection device 100 by grasping the body 10. In the embodiment where a handle 60 is provided, the handle 60 may accommodate the positioning device 40.

FIGS. 3A-3D are diagrams illustrating an assembly process of the coolant hose connector inspection device illustrated in FIG. 2.

Referring to FIG. 3A, the shaft 20 is inserted into the hollow portion of the body 10 through one end of the body 10. The handle 60 is provided at the other end of the body 10. Referring to FIG. 3B, the handle 60 is fixed to the body 10. The handle 60 may be fixed to the body 10 using fastening members such as screws, bolts and the like, or using adhesive. In another example, the handle 60 may be welded to the body 10. The button 50 is centered on the handle 60. Between the button 50 and the handle 60, a spring 52 may be inserted to provide elastic force to return the button 50 to its original position when force is not applied to the button 50. The button 50 may be fixed to the shaft 20 using a fastening member 54 such as a screw or a bolt and the like. Referring to FIG. 3C, a sensor block 32 accommodating the sensor 30 is fixed to the body 10. Referring to FIG. 3D, the positioning device 40 is fixed to the handle 60 to complete the coolant hose connector inspection device 100.

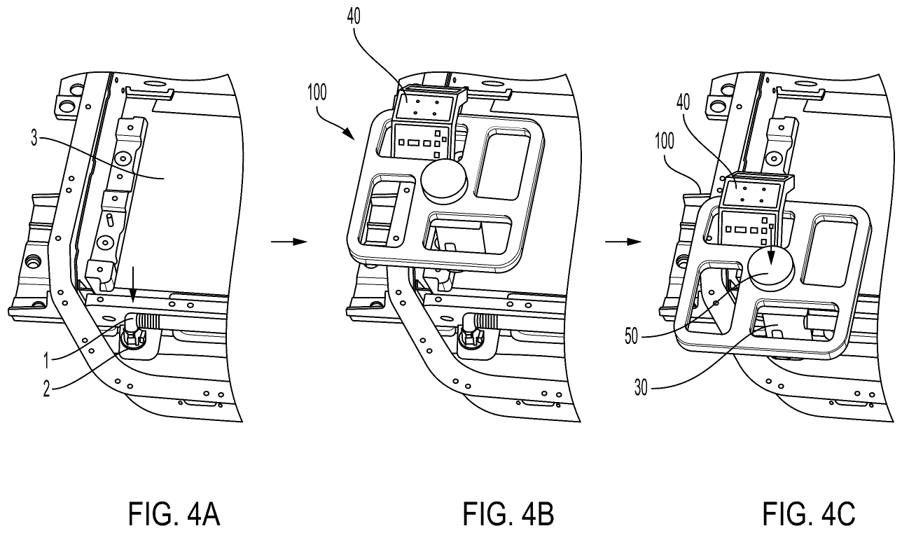

FIGS. 4A-4C are diagrams illustrating an operation of the coolant hose connector inspection device illustrated in FIG. 2.

FIG. 4A illustrates a coolant hose connector 1 seated on a coolant hose receiver 2 at a battery pack or a battery rack 3. Referring to FIG. 4B, the coolant hose connector inspection device 100 is place over the coolant hose connector 1. Here, the positioning device 40 is used to determine the location of the coolant hose connector inspection device 100, which, in this case, corresponds to the location of the coolant hose connector 1 at the battery pack or the battery rack 3. Referring to FIG. 4C, the coolant hose connector inspection device 100 is placed over the coolant hose connector 1 such that the coolant hose connector 1 and the coolant hose receiver 2 are received inside the body of the coolant hose connector inspection device 100. Then, force is exerted on the button 50, which is applied to the coolant hose connector 1 to properly seat with the coolant hose receiver 2. When the sensor 30 at the coolant hose connector inspection device 100 senses the shaft, the coolant hose connector 1 is properly seated on the coolant hose receiver 2. The sensor 30 sends a signal to the positioning device 40.

FIGS. 5A-5B are cross-sectional diagrams illustrating an internal operation of the coolant hose connector inspection device illustrated in FIG. 2.

FIG. 5A illustrates the coolant hose connector inspection device 100 placed over the coolant hose connector 1 such that the coolant hose connector 1 and the coolant hose receiver 2 are received inside the body of the coolant hose connector inspection device 100. The outermost end of one end portion of the body of the coolant hose connector inspection device 100 sits on the battery pack or the battery rack 3. Referring to FIG. 5B, in this position, a force is applied to the button 50, which moves the shaft 20 toward the one end portion of the body of the coolant hose connector inspection device 100. The shaft 20 is movable up to a predetermined distance from the outermost end of the one end portion of the body of the coolant hose connector inspection device 100, before the shaft 20 is stopped by the button 50 making contact with the handle 60. Here, the shaft 20 can no longer press the coolant hose connector 1 against the coolant hose receiver 2. An end of the shaft 20 is positioned at the predetermined distance, which corresponds to the level of the top of the coolant hose connector 1 from the outermost end of one end portion of the body of the coolant hose connector inspection device 100. In this position, the coolant hose connector 1 is properly seated on the coolant hose receiver 2. The sensor 30, which is a contact switch in this embodiment, is disposed at the body of the coolant hose connector inspection device 100 at the predetermined distance, and has the same level as the top of the coolant hose connector 1 at this point. The end of the shaft 20 makes contact with the contact switch and activates the contact switch. When activated, the contact switch sends a signal indicating that the coolant hose connector 1 is properly seated on the coolant hose receiver 2.

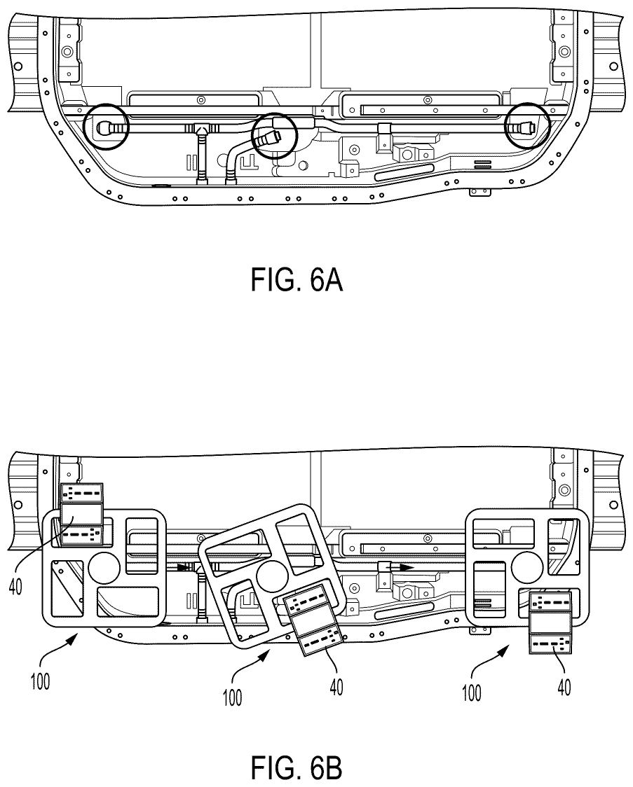

FIGS. 6A-6B are diagrams illustrating an operation of the coolant hose connector inspection device going from one connected coolant hose connector to the next connected coolant hose connector on a battery pack or a battery rack according to an embodiment of the present disclosure.

FIG. 6A illustrates three coolant hose connectors connected to respective coolant hose receivers on the battery pack or the battery rack. It should be noted that the three coolant hose connectors are for illustration purposes only and there may be less than or more than three coolant hose connectors connected to the battery pack or the battery rack. The left coolant hose connector has the coolant hose extending horizontally from left to right; the middle coolant hose connector has the coolant hose extending from left to right at an angle; and the right coolant hose connector has the coolant hose extending horizontally from right to left.

Referring to FIG. 6B, the coolant hose connector inspection device 100 may be first positioned on the left coolant hose connector. The slit at the body of the coolant hose connector inspection device 100 is positioned to face the right side and is aligned with the coolant hose. The position of the left coolant hose connector may be determined based on the positioning device 40. An operation as illustrated in FIGS. 5A-5B may be performed. Once the operation is performed, the positioning device 40 may send a signal indicating completion of the operation. Or the positioning device 40 may store information in memory indicating completion of the operation. The coolant hose connector inspection device 100 may then be positioned on the middle coolant hose connector. The slit at the body of the coolant hose connector inspection device 100 is positioned to face the left side, but angled to align with the coolant hose. The position of the middle coolant hose connector may be determined based on the positioning device 40. An operation as illustrated in FIGS. 5A-5B may be again performed. Once the operation is performed, the positioning device 40 may send a signal indicating completion of the operation. Or the positioning device 40 may store information in memory indicating completion of the operation. The coolant hose connector inspection device 100 may then be positioned on the right coolant hose connector. The slit at the body of the coolant hose connector inspection device 100 is positioned to face the left side and is aligned with the coolant hose. The position of the right coolant hose connector may be determined based on the positioning device 40. An operation as illustrated in FIGS. 5A-5B may be performed. Once the operation is performed, the positioning device 40 may send a signal indicating completion of the operation. Or the positioning device 40 may store information in memory indicating completion of the operation.

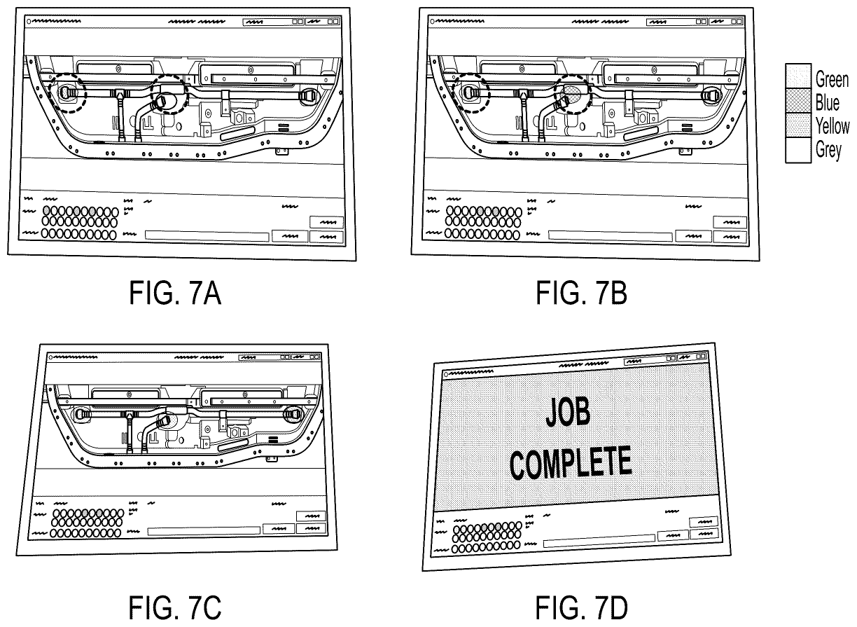

FIGS. 7A-7D are diagrams illustrating a display displaying a guide for operation of the coolant hose connector inspection device. The operation of the coolant hose connector inspection device may be similar to that performed in FIG. 6B. The display may be used to guide a user in performing the inspection of the connections of the coolant hose connectors with the coolant hose receivers. The display may be connected to a computer that receives and processes the information regarding the position of the coolant hose connector inspection device and the information regarding whether an operation as illustrated in FIGS. 5A-5B has been performed. A computer typically has an electronic processor coupled to a memory and an input/output device. The electronic processor executes programs stored in the memory to perform functions to be described below. Computers are well known in the art and will not be further described.

Referring to FIGS. 7A-7D, as the battery pack or the battery rack enters the inspection area, a camera may capture an image of the battery pack or the battery rack, which is displayed on the display. In another example, the computer may display a template of the battery pack or the battery rack on the display. For the purpose of describing FIGS. 7A-7D, a captured image of the camera will be used.

The computer may generate inspection guides superimposed on the battery pack or the battery rack image displayed on the display based on the processed information regarding the position of the coolant hose connector inspection device and the information regarding whether the operation as illustrated in FIGS. 5A-5B has been performed. For example, circular color codes may be superimposed on the coolant hose connectors at the battery pack or the battery rack image. However, other schemes may be used such as symbols, wordings, patterns, etc. In this example, the circular color codes may be “gray” for inspection not started; “yellow” for inspection to be started; “blue” for position of the coolant hose connector inspection device; and “green” for inspection completed. Examples of using the circular color codes will now be described using FIGS. 7A-7D.

FIG. 7A illustrates a display when the battery pack or the battery rack has entered the inspection area. The captured image is displayed on the display. The image is displaying a portion of the battery pack or the battery rack with three coolant hose connectors attached. The three coolant hose connectors are for illustration only, and there may be less than or more than three coolant hose connectors. The computer superimposes on the image, a yellow circle on the left coolant hose connector, and a gray circle on the middle and right coolant hose connectors. The user observing that the left coolant hose connector has a yellow circle will proceed to place the coolant hose connector inspection device over the left coolant hose connector. The user will then perform an operation such as that illustrated in FIGS. 5A-5B.

When the computer receives information regarding the position of the coolant hose connector inspection device that corresponds with the position of the left coolant hose connector, and receives information regarding that the operation as illustrated in FIGS. 5A-5B is completed, the computer superimposes on the image, a green circle on the left coolant hose connector indicating that the inspection is completed, and proceeds to superimpose a yellow circle on the middle coolant hose connector indicating that the inspection should be started on the middle coolant hose connector, while retaining a gray circle on the right coolant hose connector.

FIG. 7B illustrates a display displaying a green circle on the left coolant hose connector indicating that the inspection is completed, and a blue circle on the middle coolant hose connector indicating that the coolant hose connector inspection device is over the middle coolant hose connector, while the right coolant hose connector has a gray circle. It should be noted that the computer may follow a strict inspection guideline in order to avoid any inadvertent omission of an inspection on the coolant hose connectors.

For example, suppose that after inspecting the left coolant hose connector, the user skips the middle coolant hose connector even though the middle coolant hose connector has a yellow circle, and proceeds to the right coolant hose connector. The computer may superimpose a blue circle on the right coolant hose connector, but the computer will retain the yellow circle on the middle coolant hose connector. The user may perform the operation as illustrated in FIGS. 5A-5B on the right coolant hose connector, but the computer will not recognize the performance by superimposing a green circle on the right coolant hose connector, but instead retains the blue circle on the right coolant hose connector and the yellow circle on the middle hose connector. The inspection will continue when the user places the coolant hose connector inspection device over the middle coolant hose connector, which the computer will respond by superimposing a blue circle on the middle coolant hose and a gray circle on the right coolant hose connector.

FIG. 7C illustrates a display displaying a green circle on the left and middle coolant hose connectors indicating that the inspection on the left and middle coolant hose connectors have been performed, and a yellow circle on the right coolant hose connector indicating that an inspection should be started. It should be noted that, continuing with the example above, that even though the user skipped the middle coolant connector and performed the operation as illustrated in FIGS. 5A-5B on the right coolant hose connector previously, the performance is not acknowledged by the computer. Accordingly, the user has to perform the operation as illustrated in FIGS. 5A-5B on the right coolant hose connector again. FIG. 7D illustrates a display indicating that the inspection on the coolant hose connectors on the battery pack or the battery rack has been completed.

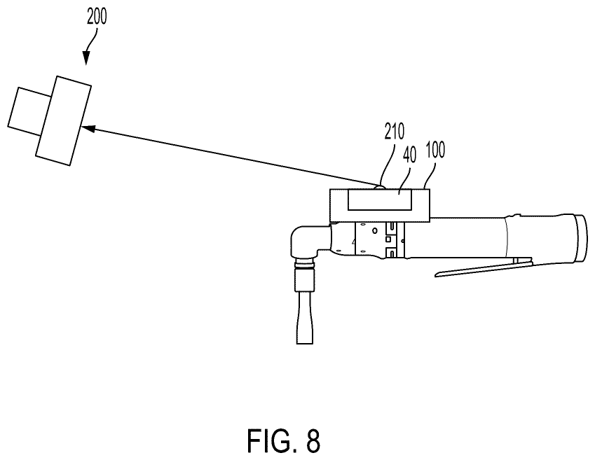

FIG. 8 is a diagram illustrating a position sensor apparatus according to another embodiment of the present disclosure. The position sensor apparatus may include an infrared (IR) camera 200 and an IR emitter 210 on the positioning device 40. For example, the IR emitter 210 may use an IR light emitting diode (LED). The IR camera 200 may be positioned at the inspection area to capture an image of the coolant hose connectors connected on the battery pack or the battery rack. In this embodiment, the positioning device 40 is relatively passive in terms of determining the position of the coolant hose connector inspection device 100. The positioning device 40 emits an IR light from the IR emitter 210, which is detected by the IR camera 200. The IR camera 200 may include a complementary metal-oxide semiconductor (CMOS) image sensor, which captures the image including the IR light from the IR emitter 210. Depending on where the IR light falls on the surface area of the CMOS image sensor and the known distance from the IR camera to the battery pack or the battery rack, the computer is able to determine the position of the coolant hose connector inspection device. To indicate that the operation as illustrated in FIGS. 5A-5B has been performed, the positioning device 40 may blink the IR emitter. Or the positioning device 40 may separately send a signal wirelessly, for example, to the computer. The computer having this information may perform the operations illustrated in FIGS. 7A-7D, for example.

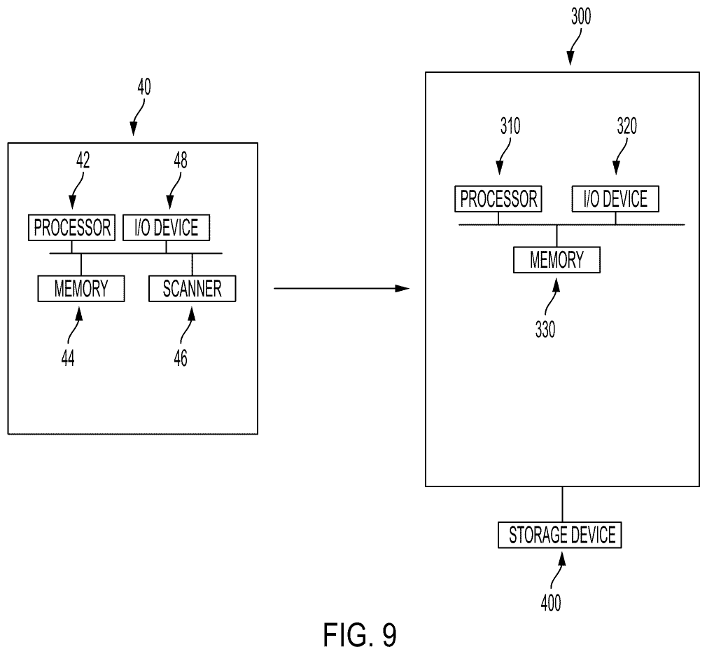

FIG. 9 is a diagram illustrating another positioning device and a manufacturing execution system (MES) 300 according to an embodiment of the present disclosure. The positioning device 40 may include an electronic processor 42, a memory 44, an I/O device 48, and further may include a scanner 46. A scanner 46 is provided to the positioning device 40, for example, to scan a bar code or other identification marks or symbols that may identify the battery pack or the battery rack. If the battery pack or the battery rack is already pre-identified, then the scanner may not be required in the positioning device 40. For example, the computer described with respect to FIGS. 7A-7D may have received the identification information by scanning the battery pack or the battery rack, or through data entry by the user. In the example, where the battery pack or the battery rack is not pre-identified, the electronic processor 42 receives identification information of the battery pack or the battery rack and stores the information in the memory 44. The electronic processor 42 receives information regarding the position of the coolant hose connector and the information regarding operation of FIGS. 5A-5B through the I/O device 48. Once all the information regarding the position of the coolant hose connector and the information regarding operation of FIGS. 5A-5B for the inspected battery pack or the battery rack is received, the positioning device may send out the identification information of the battery pack or the battery rack, and all the information regarding the position of the coolant hose connector and the information regarding operation of FIGS. 5A-5B for the inspected battery pack or the battery rack through the I/O device 48.

The positioning device 40 may send the stored information directly to the MES 300, or the positioning device 40 may send the information to the computer described with respect to FIGS. 7A-7D. The computer may then send the information to the MES 300. It should be noted that the computer may already have stored therein the identification information of the battery pack or the battery rack. In this instance, the positioning device 40 may send just the information regarding the position of the coolant hose connector and the information regarding operation of FIGS. 5A-5B, which the computer will match with the identification information of the battery pack or the battery rack before sending all the information to the MES 300.

The MES 300 may include an electronic processor 310, an I/O device 320, and a memory 330. The MES 300 may receive the identification information of the battery pack or the battery rack, and all the information regarding the position of the coolant hose connector and the information regarding operation of FIGS. 5A-5B for the inspected battery pack or the battery rack through the I/O device 320. The processor 310 may then store the information in the storage device 400. The storage device 400 is a long term storage device and may include a hard disk device, a tape device, a solid state device (SSD), and the like.

It should be noted that the above-described implementation is not the sole method for achieving the objectives. Alternative configurations and technologies can be explored based on specific needs and preferences. Additionally, it should be understood that the adaptability of the coolant connector inspection device, and its design can be customized to suit different connector types and applications. The coolant connector inspection device's flexibility allows for integration into diverse manufacturing environments. Lastly, potential collaborations with experts in sensor technologies or industrial automation could further enhance its overall effectiveness and applicability.

Aspects of the present disclosure that are implemented by software may be implemented by instructions that are stored in a memory and executed by an electronic processor. The memory may be installed inside or outside the processor and may be connected to the processor via various well-known means. The processor may include Application-Specific Integrated Circuit (ASIC), other chipsets, a logical circuit, and the like. The memory may include a Read-Only Memory (ROM), a Random Access Memory (RAM), a flash memory, a memory card, a storage medium, and/or other storage device.

In the above, the present disclosure has been described in more detail through the drawings and aspects. However, the configurations described in the drawings or the aspects in the specification are merely aspects of the present disclosure and do not represent all the technical ideas of the present disclosure. Thus, it is to be understood that there may be various equivalents and variations in place of them at the time of filing the present application which are encompassed by the claims.

What is claimed is:

1. A connector inspection device comprising:
a body including one end portion and another end portion, the one end portion including a hollow portion to receive a coolant hose and a coolant hose connector;
a positioning device disposed at the body for obtaining a position of the connector inspection device;
a shaft disposed in the body and movable toward the one end portion of the body, the shaft movable up to a predetermined distance from an outermost end of the one end portion of the body; and
a sensor disposed at the body,
wherein, when the shaft is positioned at the predetermined distance in the body, the sensor is configured to sense the shaft.

2. The connector inspection device of claim 1, wherein the shaft comprises a button for applying a force to push the shaft through the body.

3. The connector inspection device of claim 1, wherein the body comprises a handle at which the positioning device is disposed.

4. The connector inspection device of claim 1, wherein the predetermined distance is a distance from an outmost end of the one end portion of the body where the shaft cannot further press the coolant hose connector against a coolant hose receiver.

5. The connector inspection device of claim 1, wherein the sensor is configured to activate when the shaft is positioned at the predetermined distance in the body.

6. The connector inspection device of claim 5, wherein the sensor is a contact switch that is activated when the shaft contacts the contact switch.

7. The connector inspection device of claim 5, wherein the sensor is configured to communicate with the positioning device when the sensor is activated.

8. The connector inspection device of claim 1, wherein the positioning device comprises a light emitting diode (LED).

9. The connector inspection device of claim 8, wherein the LED is an infrared (IR) LED.

10. A monitoring system including the connector inspection device of claim 8, further comprising a camera to capture light of the LED in order to determine at least an X-Y coordinate of the positioning device.

11. The monitoring system of claim 10, wherein the camera is configured to capture light of the LED indicating that the sensor is activated.

12. The monitoring system of claim 11, wherein the monitoring system is configured to sent data including the at least X-Y coordinate of the positioning device and the activation of the sensor to a manufacturing execution system (MES).

13. The monitoring system of claim 11, further comprising a display to display at least one or more coolant hose connectors, and at least one or more indicators to indicate a status of the at least one or more coolant connectors.

14. The monitoring system of claim 13, wherein a first indicator indicates a coolant hose connector in which the connector inspection device is to be applied.

15. The monitoring system of claim 14, wherein when the display system receives data including at least the X-Y coordinate of the positioning device and the activation of the sensor, the display device is configured to match the at least X-Y coordinate of the positioning device with the coolant hose connector indicated by the first indicator, and when the at least X-Y coordinate of the positioning device does not correspond with the position of the coolant hose connector, the display system is configured to continue displaying the first indicator.

16. The monitoring system of claim 13, wherein when the at least X-Y coordinate of the positioning device corresponds with the position of the coolant hose connector, the display system is configured to change the first indicator to a second indicator.

17. The monitoring system of claim 13, wherein a third indicator indicates a next coolant hose connector in which the connector inspection device is to be applied.

18. The monitoring system of claim 13, wherein one or more fourth indicators indicates one or more coolant hose connectors in which the connector inspection device has not been applied.
